(19) United States
(12) Patent Application Publication
(10) Pub. No.: US 2026/0019353 A1
(43) Pub. Date: Jan. 15, 2026

(54) QUALITY OF SERVICE COORDINATION FOR A VIRTUAL EXPERIENCE SERVICE IN A WIRELESS COMMUNICATIONS NETWORK

(71) Applicant: LENOVO (SINGAPORE) PTE. LTD, Singapore (SG)

(72) Inventors: Emmanouil Pateromichelakis, Viersen (DE); Dimitrios Karampatsis, Ruislip (GB)

(73) Assignee: Lenovo (Singapore) Pte. Limited, Singapore (SG)

(21) Appl. No.: 18/881,098

(22) PCT Filed: Aug. 24, 2022
(86) PCT No.: PCT/EP2022/073567

§ 371 Date: Jan. 3, 2025

(30) Foreign Application Priority Data
Jul. 6, 2022 (GR) 20220100537

(51) Int. Cl. H04L 43/0817; H04L 41/40

(52) U.S. Cl. CPC H04L 43/0817; H04L 41/40

(57) ABSTRACT

There is provided an enablement entity for a virtual experience service, the enablement entity in a wireless communication network, the enablement entity comprising a receiver, a processor and a transmitter. The receiver is arranged to receive an application service requirement corresponding to a plurality of devices, the plurality of devices operating in physical space, or in a virtual space of the virtual experience service, or both. The processor is arranged to decompose the application service requirement to a plurality of session requirements, wherein the session requirements apply to a plurality of communication sessions, the communication sessions provided between devices in both physical space and virtual space, and to derive a set of joint quality of service parameters for the plurality of sessions based on the session requirements. The transmitter is arranged to send the set of joint quality of service parameters to one or more network entities in the wireless communication network.

### FIELD

The subject matter disclosed herein relates generally to the field of implementing quality of service coordination for a virtual experience service in a wireless communications network. This document defines an enablement entity for a virtual experience service, and a method in an enablement entity for a virtual experience service.

### BACKGROUND

Virtual reality (VR), Augmented Reality (AR) and Extended Reality (XR) are types of virtual space whereby users of electronic devices can interact with each other. The electronic devices may communicate using the wireless communication network. Such a virtual space can use cryptocurrency to conduct transactions. Such transactions may comprise the exchange of digital works including, but not limited to, non-fungible tokens (NFTs).

The metaverse is an example of such a virtual space. The metaverse is an open, shared, and persistent virtual world that offers access to the 3D virtual spaces, solutions, and environments created by users. The metaverse is a digital reality that combines aspects of social media, online gaming, augmented reality (AR), virtual reality (VR), and cryptocurrencies to allow users to interact virtually. As the metaverse grows, it will create online spaces where user interactions are more multidimensional than current technology supports. Instead of just viewing digital content, users in the metaverse will be able to immerse themselves in a space where the digital and physical worlds converge.

In the Metaverse, everything the user creates and owns in the metaverse is their asset, whether it is a piece of virtual real estate or an artifact. The metaverse confers the privileges of complete ownership on its users. Moreover, the persistency factor is very important since even if a user exits the metaverse, the digital avatar would still be in the metaverse. It would run normally with other users engaging and interacting with the metaverse. An avatar, a digital object, a virtual device, an object in the metaverse, and a digital twin are all different representations of the objects/devices instantiated/deployed in the virtual space of the virtual experience service. By some definitions, avatars are our digital representatives in the virtual space. For example, a metaverse avatar of a user is essentially a manifestation of the user and/or their user equipment within the metaverse. The avatar can look exactly like the user or device looks in the real world or can be augmented. As such, an avatar UE can be considered to be a digital representation of the user's device virtualized in the metaverse. The user's device may be a mobile phone, a cellular telephone, smart glasses, and/or a smartwatch.

There is a need for optimizing delivery of virtual experience services in a wireless communication network.

### SUMMARY

To support traffic flow simulation and situational awareness service for a virtual experience service, the wireless communication network needs to provide low latency, high data rate and high reliability transmission. The wireless communication network may also need to be enhanced to meet the service requirements for traffic flow simulation and situational awareness. Meanwhile, in addition to the real objects which may host the UE for cellular system, their corresponding virtual objects are also capable of interacting with each other and to interact with physical objects via the wireless communication network. There is thus a need to optimize the implementation of virtual experience services in a wireless communication network.

Disclosed herein are procedures for quality of service coordination for a virtual experience service in a wireless communications network. Said procedures may be implemented by an enablement entity for a virtual experience service, and a method in an enablement entity for a virtual experience service.

There is provided an enablement entity for a virtual experience service, the enablement entity in a wireless communication network, the enablement entity comprising a receiver, a processor and a transmitter. The receiver is arranged to receive an application service requirement corresponding to a plurality of devices, the plurality of devices operating in physical space, or in a virtual space of the virtual experience service, or both. The processor is arranged to decompose the application service requirement to a plurality of session requirements, wherein the session requirements apply to a plurality of communication sessions, the communication sessions provided between devices in both physical space and virtual space, and to derive a set of joint quality of service parameters for the plurality of sessions based on the session requirements. The transmitter is arranged to send the set of joint quality of service parameters to one or more network entities in the wireless communication network.

There is further provided a method in an enablement entity for a virtual experience service, the enablement entity in a wireless communication network. The method comprises receiving an application service requirement corresponding to a plurality of devices, the plurality of devices operating in physical space, or in a virtual space of the virtual experience service, or both. The method further comprises decomposing the application service requirement to a plurality of session requirements, wherein the session requirements apply to a plurality of communication sessions, the communication sessions provided between devices in both physical space and virtual space, and deriving a set of joint quality of service parameters for the plurality of sessions based on the session requirements. The method further comprises sending the set of joint quality of service parameters to one or more network entities in the wireless communication network.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for quality of service coordination for a virtual experience service in a wireless communications network will now be described, by way of example only, with reference to the accompanying drawings, in which:

FIG. 1 depicts a wireless communication system for quality of service coordination for a virtual experience service in a wireless communications network;

FIG. 2 depicts a user equipment apparatus that may be used for implementing the methods described herein;

FIG. 3 depicts further details of a network node that may be used for implementing the methods described herein;

FIG. 4 illustrates a multi-modal feedback service implemented in a wireless communication network;

FIG. 5 illustrates 5G-enabled Traffic Flow Simulation including Situational Awareness;

FIG. 6 illustrates a method in an enablement entity for a virtual experience service, the enablement entity in a wireless communication network;

FIG. 7 illustrates an example of a multi-modal session and Multi-modal data flow group;

FIG. 8 illustrates a system as an example implementing of the methods described herein;

FIG. 9 illustrates possible sessions for a virtual experience service;

FIG. 10 illustrates four different application sessions that can be present in a virtual experience service such as a mobile metaverse service;

FIG. 11 shows the operation of an enablement server operating as a QoS coordination function; and

FIG. 12 illustrates a method for the coordination of PDU sessions at a meta-control network function.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

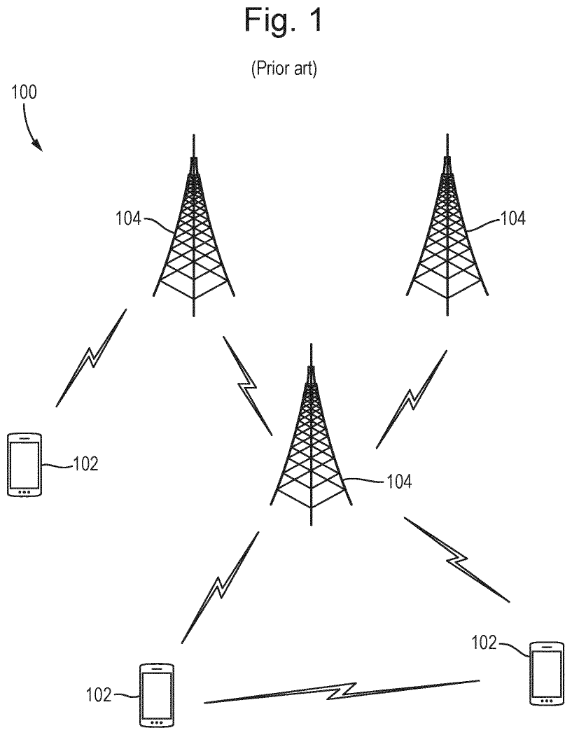

FIG. 1 depicts an embodiment of a wireless communication system 100 for quality of service coordination for a virtual experience service in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may comprise a user equipment apparatus 200, or a UE 710, 720, 810, 910, 912, 1010, 1020, 1110, 1120 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

The wireless communication system can be adapted to more efficiently suit use cases and potential requirements for localized metaverse services. Some examples of such use cases are discussed below.

Since the industrial age, engineering design has become an extremely demanding activity. Collaborative and concurrent engineering occur as a concept and methodology at the end of the last century and was defined as a systematic approach to integrated and co-design of products and their related processes. The diversity and complexity of actual products, requires collaboration of engineers from different geographic locations to share the ideas and solutions with customer and to evaluate products development. VR and AR technologies have found their ways into critical applications in industrial sectors such as aerospace engineering, automotive engineering, medical engineering, and in the fields of education and entertainment. The range of technologies include Cave Automatic Virtual Environment (better known by the recursive acronym CAVE) environments, reality theatres, power walls, holographic workbenches, individual immersive systems, head mounted displays, tactile sensing interfaces, haptic feedback devices, multi-sensational devices, speech interfaces, and mixed reality systems.

Mobile metaverse based multi-modal feedback service describes a case of multi-physical entities or their digital avatars interacting with each other. New feedback modalities are also introduced in this use case to satisfy new scenarios and requirements in the mobile metaverse. Note that mobile metaverse is a cyberspace parallel to the real world, which tends to make the virtual world more realistic and make the real world richer. Such a service tends to better utilize different feedback cues and achieve multi-modal feedback cues to adapt to different scenarios, satisfying the accuracy of the task and user experience, and so on. More modalities should be explored to meet more immersion requirements of the physical entities in the real world such as smell and taste. To realize a more immersive requirement of different scenarios in the mobile metaverse, it is important to explore these temporal in-sync or out-of-sync boundaries for audio, video, haptic, scent, taste, and so on.

Physical devices, physical entities and physical objects exist in physical space, which may be referred to as the real-world. This is in contrast to virtual devices, virtual entities and virtual objects which exist in the virtual space of a virtual experience service. There may be a mapping between physical devices, physical entities and physical objects and to virtual devices, virtual entities and virtual objects. The mapping may be one-to-one, many-to-one, or one-to-many. Physical space can be defined as the physical world or real environment comprising, among others, the physical objects and/or devices running the software that delivers the virtual experience service. Hardware that delivers the virtual experience service may be distributed geographically and distributed over different software environments. The hardware may be located physically close to where the physical users of the virtual experience service are physically located.

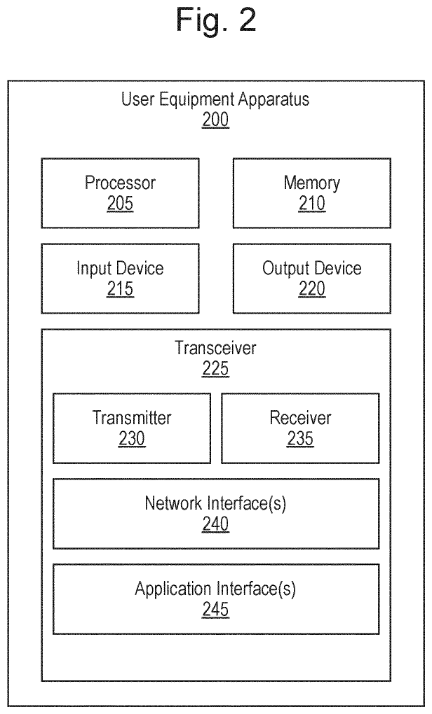

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102 or a UE 710, 720, 810, 910, 912, 1010, 1020, 1110, 1120 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

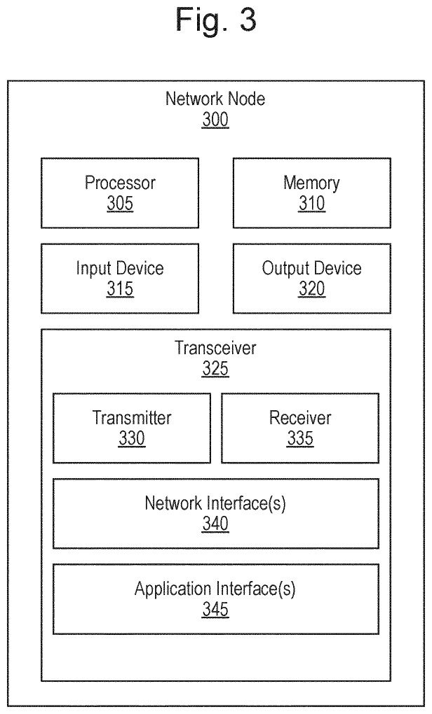

FIG. 3 depicts further details of the network node 300 that may be used for implementing the methods described herein. The network node 300 may be one implementation of an entity in the wireless communications network, e.g. in one or more of the wireless communications networks described herein. The network node 300 may be, for example, a network function configured to support a virtual experience service, a meta-aware network function 852, a meta enabler 1052, 1152, or a meta-control network function 1243. In a further implementation, the network node 300 may be deployed as an application function specific to a virtual experience service (which may include XR, AR, VR and/or MR). Further, the network node 300 may comprise an application server which resides at an edge server, a cloud server, or a server in the wireless communication system. The network node 300 may be a meta-aware application function (AF), a media streaming application function, or a media streaming application server which provides support for mobile metaverse services. Such a network node may be implemented consistent with 3GPP SA4.

The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

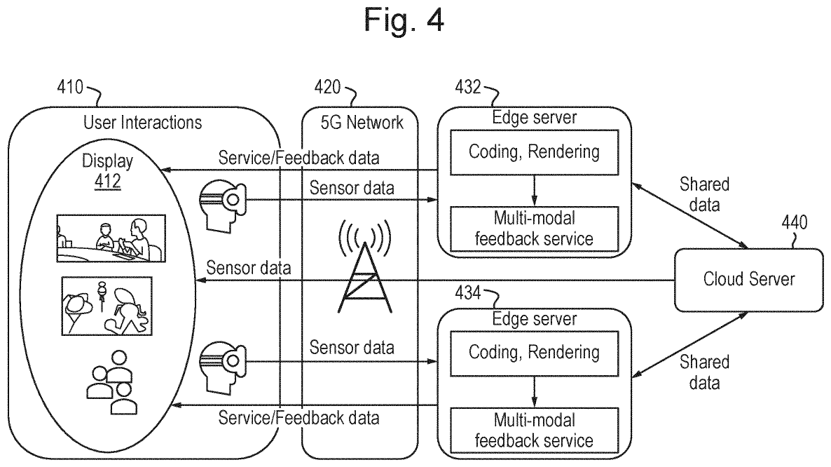

FIG. 4 illustrates a multi-modal feedback service implemented in a wireless communication network. User interactions 410 with a user equipment having a display 412 are captured as sensor data which is sent via a 5G network 420 to one or more edge servers 432, 434. The user equipment is arranged to run an application for allowing a user to interact with the metaverse. Each Edge server 432, 434 may provide coding and rendering services and multi-modal feedback service. The edge server 432, 434 sends service data and/or feedback data back to the user equipment. The edge server 432, 434 sends shared data to a cloud server 440. A mobile metaverse based multi-modal feedback service may be deployed at the edge/cloud server 432, 434, 440 for different scenarios. During the application running period, the physical entities of the wireless communication network may deliver an immersive experience to the users via their avatars, and the multi-modal feedback data may be exchanged with each other, whether the physical entities are in proximity or non-proximity. FIG. 4 illustrates how the multi-modal feedback service is applied in the mobile metaverse, and the major impact on 3GPP is whether and how 5GS can be used to better utilize different feedback cues and achieve multi-modal feedback cues concerning the experiences of the multi-physical entities.

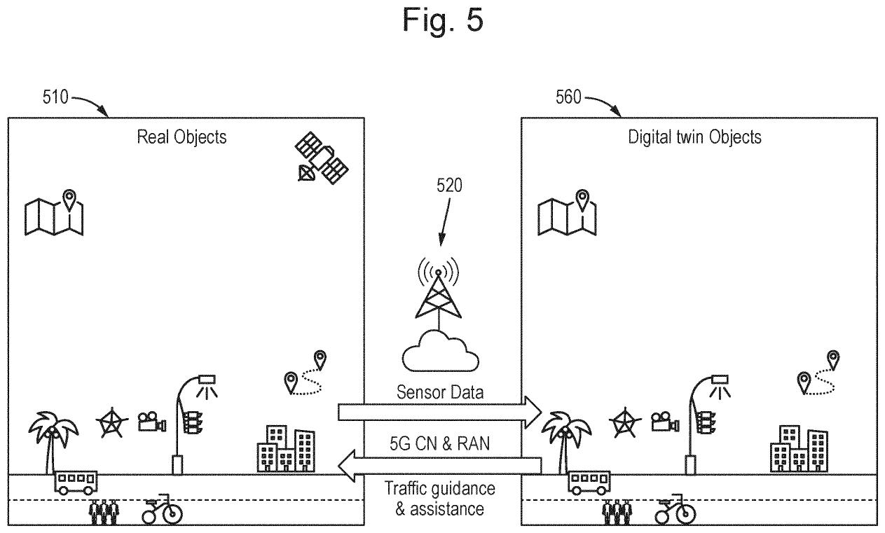

FIG. 5 illustrates 5G-enabled Traffic Flow Simulation including Situational Awareness. With the support of 5GS, real-time information and data about the real objects can be delivered to virtual objects in the metaverse. FIG. 5 shows a plurality of real objects 510, and a virtual world comprising a plurality of digital twin objects 560. A wireless communication network 520 carries sensor data from the real objects 510 and delivers this to the digital twin objects 560. The wireless communication network 520 delivers situational information from the digital twin objects 560 in the virtual space back to the real objects 510. Such situational information may comprise traffic guidance and assistance data. In this way, the road infrastructure and traffic participants including vulnerable road users can form a smart transport metaverse. Then real-time processing and computing can be conducted to support traffic simulation and also situational awareness and real time path guidance and real-time safety, or security alerts can be generated for ICVs as well as the driver and passengers.

To support traffic flow simulation and situational awareness service, the 5G network 520 needs to provide low latency, high data rate and high reliability transmission, and in addition, the 5G network 520 may also need to be further enhanced to meet the service requirements for 5G-enabled traffic flow simulation and situation awareness. Meanwhile, in addition to the real objects 510 which may host the UE for cellular system, their corresponding virtual objects 560 are also capable of interacting with each other and interact with physical objects 510 via 5GS.

There is provided an enablement entity for a virtual experience service, the enablement entity in a wireless communication network, the enablement entity comprising a receiver, a processor and a transmitter. The receiver is arranged to receive an application service requirement corresponding to a plurality of devices, the plurality of devices operating in physical space, or in a virtual space of the virtual experience service, or both. The processor is arranged to decompose the application service requirement to a plurality of session requirements, wherein the session requirements apply to a plurality of communication sessions, the communication sessions provided between devices in both physical space and virtual space, and to derive a set of joint quality of service parameters for the plurality of sessions based on the session requirements. The transmitter is arranged to send the set of joint quality of service parameters to one or more network entities in the wireless communication network.

Such an enablement entity provides a mechanism for quality of service coordination for multiuser and multimodal virtual experience services. The enablement entity can be at the 5GC or at the edge/cloud SP domain and supports the translation of requirements between the virtual experience service and an underlying wireless communication network. The enablement entity may further optimize performance by compensating for possible quality of service changes for one or more sessions.

The virtual experience service may comprise the metaverse. The virtual experience service may be the mobile metaverse.

The plurality of devices may operate in physical or virtual space, or both, and may comprise: physical devices, digital devices, network entities, application entities or a combination thereof.

The received application service requirement may comprise at least one of: a set of performance requirements for a virtual experience service; subscriptions associated with the plurality of devices; identities and addresses of the plurality of devices; a request for coordinating the QoS for the mobile virtual experience service; a virtual experience application service profile; and/or a service area for which the requirement applies, or a combination thereof.

The application service requirement may be received from a virtual experience service provider and/or a network management system.

The per session requirements may be either network session requirement or application session requirements and may comprise quality of service and/or quality of experience targets.

The processor may be arranged to derive a set of joint quality of service parameters based on running at least one simulation at the virtual space, the simulation using digital twins of the plurality of devices. The simulation may comprise a hypothetical quality of service parameterization for one or more sessions.

Running the at least one simulation may comprise the processor being further arranged to: request simulations from a simulation engine based on digital twins for a set of hypothetical parameters; receive simulation outputs based on the requested simulations; and process the simulation outputs to determine quality of service parameters per session.

In such a way, within the virtual experience service, which may comprise a virtual space, or a metaverse, service performance can be optimized to use a minimum footprint of network resources to deliver a defined quality of service and quality of experience.

The derived joint quality of service parameters may determine service provisioning policies for the virtual space to be applied by at least one respective network function.

The receiver may be further arranged to receive an event related to a quality of service change for one or more sessions. The processor may be arranged to adapt the set of joint quality of service parameters for the plurality of sessions based on the received event. The transmitter may be arranged to send the adapted set of joint quality of service parameters for the plurality of sessions to one or more network or application entities.

The event related to a quality of service change may be received from one of the plurality of devices operating in physical or virtual space, or from a network element in the wireless communication network.

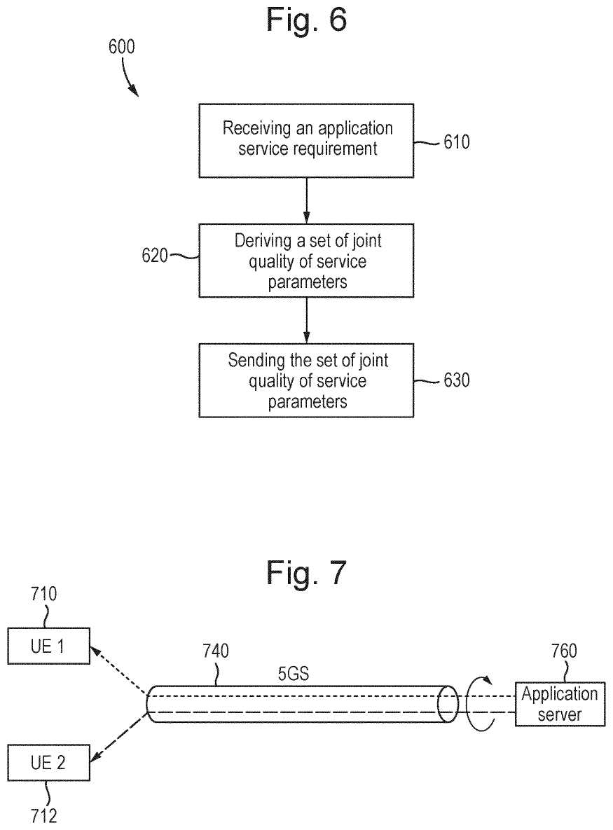

FIG. 6 illustrates a method 600 in an enablement entity for a virtual experience service, the enablement entity in a wireless communication network. The method 600 comprises receiving 610 an application service requirement corresponding to a plurality of devices, the plurality of devices operating in physical space, or in a virtual space of the virtual experience service, or both. The method 600 further comprises decomposing 620 the application service requirement to a plurality of session requirements, wherein the session requirements apply to a plurality of communication sessions, the communication sessions provided between devices in both physical space and virtual space, and deriving a set of joint quality of service parameters for the plurality of sessions based on the session requirements. The method 600 further comprises sending 630 the set of joint quality of service parameters to one or more network entities in the wireless communication network.

Such a method provides a mechanism for quality of service coordination for multiuser and multimodal virtual experience services. The enablement entity can be at the 5GC or at the edge/cloud SP domain and supports the translation of requirements between the virtual experience service and an underlying wireless communication network. The method may further result in optimizing performance by compensating for possible quality of service changes for one or more sessions.

The virtual experience service may comprise the metaverse. The virtual experience service may be the mobile metaverse.

The plurality of devices operating in physical or virtual space, or both, may comprise: physical devices, digital devices, network entities, application entities or a combination thereof.

The received application service requirement may comprise at least one of: a set of performance requirements for a virtual experience service; subscriptions associated with the plurality of devices; identities and addresses of the plurality of devices; a request for coordinating the QoS for the mobile virtual experience service; a virtual experience application service profile; and a service area for which the requirement applies, or a combination thereof.

The application service requirement is received from a virtual experience service provider and/or a network management system.

The per session requirements may be either network session requirement or application session requirements and may comprise quality of service (QoS) and/or quality of experience (QoE) targets. A QoS parameter may be a metric such as jitter, delay/latency, packet error rate, channel loss, data rate/throughput, connection density, communication service availability probability, relative delay/latency among two or more digital and/or physical devices, update rate, and/or encoding rate for media traffic. A QoE parameter may comprise a metric such as user satisfaction, metrics related to Average Throughput, Buffer Level, Play List, Presentation Delay, Field of View, Resolution, Refresh Rate, MOS (“Mean Opinion Score”), frequency and/or duration of stalling events, occurrence of transport discontinuities (including duration thereof), and/or High-resolution Real-time Video Quality. The QoS and QoE targets may be based on those defined for VR in 3GPP TR 26.929 v17.0.0.

Deriving a set of joint quality of service parameters may be based on running at least one simulation at the virtual space, the simulation using digital twins of the plurality of devices. The simulation may comprise a hypothetical quality of service parameterization for one or more sessions.

Running the at least one simulation may comprise: requesting simulations from a simulation engine based on digital twins for a set of hypothetical parameters; receiving simulation outputs based on the requested simulations; and processing the simulation outputs to determine quality of service parameters per session.

Some typical performance requirements for a virtual experience service are illustrated in Table 1 below.

TABLE 1
Typical performance requirements for multi-modal streams

| | Haptics | Video | Audio |
|---|---|---|---|
| Jitter (ms) | ≤2 | ≤30 | ≤30 |
| Delay (ms) | ≤50 | ≤400 | ≤150 |
| Packet loss (%) | ≤10 | ≤1 | ≤1 |
| Update rate (Hz) | ≥1000 | ≥30 | ≥50 |
| Packet size (bytes) | 64-128 | ≤MTU | 160-320 |
| Throughput (kbit/s) | 512-1024 | 2500-40000 | 64-128 |

In the scenarios of multi-modal communication service to multiple UEs, different UEs are served by the different PCFs individually. Each PCF generates a QoS policy for each multi-modal data flow for different UEs. The mechanism presented herein tends to guarantee each of the multi-modal data flows has the same QoS policy applied.

The solution presented herein addresses scenarios concerning how multiple PCFs coordinate the QoS policy of multiple UEs' flows (e.g. haptic, audio and video) within a multi-modal communication session.

FIG. 7 illustrates an example of a multi-modal session and Multi-modal data flow group. FIG. 7 shows a first UE 710 and a second UE 712 communicating with an application server 760 over a 5G communication system (5GS) 740. A first multi-modal session carries traffic between the first UE 710 and the application server 760. A second multi-modal session carries traffic between the first UE 712 and the application server 760. The UEs 710, 720 may each comprise a remote unit 102, a user equipment apparatus 200, or a UE 810, 910, 912, 1010, 1020, 1110, 1120 as described herein.

The virtual experience service such a metaverse scenario is different from the XR use case, mainly due to the persistent nature, the multi-user support, and the ownership/business model. Such difference may require different network support and in particular different handling of quality of service (QoS) and quality of experience (QoE) targets.

The arrangements presented herein configure and coordinate QoS for the sessions within a virtual experience service to ensure meeting a target end to end QoS/QoE.

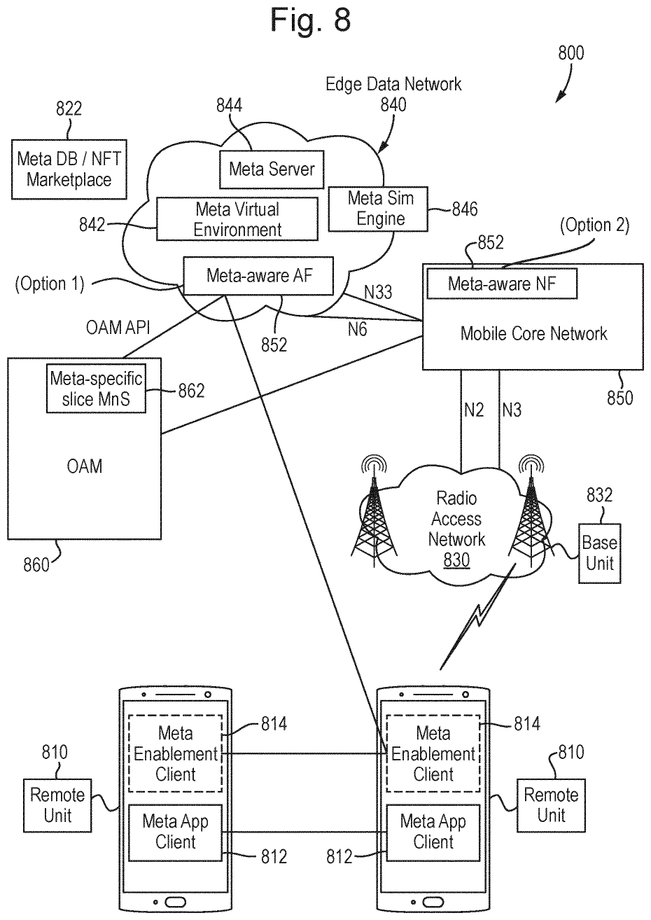

FIG. 8 illustrates a system 800 as an example implementing of the methods described herein. The system 800 comprises a plurality of remote units 810, a radio access network 830 comprising at least one base unit 832, a mobile core network 850, an Operations, Administration and Maintenance (OAM) 860, and an edge data network 840 that comprises a meta server 844. The UEs 810 may each comprise a remote unit 102, a user equipment apparatus 200, or a UE 710, 720, 910, 912, 1010, 1020, 1110, 1120 as described herein.

A meta database 822 provides Meta profiles and includes an objects database. The meta database 822 may include a Marketplace. Interaction with the meta database 822 can be via a blockchain or some distributed ledger technology network. A Meta profile can be in certain implementations one or more NFTs (hence the meta database 822 may operate as an NFT marketplace and storage).

The meta database 822 may store data related to the operation of the mobile metaverse service. Such data may comprise Meta profiles and objects or NFTs owned by end users. Such profiles and objects are uploaded at the meta database 822 from the meta user (which can be the platform where the NFT transactions happen or a data storage entity at the service provider domain).

The meta database 822 may store Meta profiles/objects or NFTs owned by Meta service provider such profiles/objects are pre-configured at the meta database 822 by the meta-service provider. Such objects can be environment objects to be used at the meta world, e.g. a table, a bot or some parameters which can change real time (e.g. the weather changes to be shown at the virtual world)

The meta database 822 may store NFTs owned by mobile network operator (MNO) this is the case when the communication and computational resources are digitized and provided as a means of interaction between virtual objects. For example, a communication link between two avatars or a network slice to be used for communication between physical and virtual devices can be provided as an NFT by the MNO. So, the service provider may buy this service for the meta world service, by interacting with the NFT marketplace/meta database 822. This allows the meta service provider to automatically reserve dedicated slice/resources for the communication using the blockchain network (no mediator).

The edge data network 840 includes a Meta Virtual Environment 842, which is a virtual environment that can be also within the meta server 844, and includes the metaverse world created, without the avatars/networked virtual devices or dynamic objects. In such environment, the visualization of objects can be possible. Further, rendering may be provided based on object IDs to recreate avatars and links between avatars.

The meta Server 844 is the processing entity where the metaverse service runs. Such a server can be an edge deployed/native server or a centralized/cloud server or a federated server (across multiple edge/clouds). The meta server 844 is deployed by the meta-service provider and is hosted at a edge/cloud of the wireless communication network. Such a server 844 can provide gaming meta services, social network services, vertical services etc.

Each remote unit 810 comprises a meta application client 812 and a meta enablement client 814. The meta-application client 812 is the application at the UE side (e.g. VR headset) which runs the mobile metaverse service. The meta enablement client 814 is the application enabler at the UE side which provides support or “awareness” to the meta-applications. Possible capabilities of the meta enablement client 814 include the translation of quality of experience (QoE) to requested network quality of service (QoS), and/or traffic steering, monitoring network conditions, and supporting the collection of sensor data and delivery of them. Traffic steering may be implemented by way of a UE route selection policy rules.

The edge data network 840 further comprises a Meta Simulation Engine 846. The meta simulation engine 846 is a platform that creates data samples based on digital twins and provides performance measurements under different what-if-scenarios. The Meta Server 844 can consume these outputs to improve user experience, or pro-actively adapt behavior or trigger network requirement changes. The meta simulation engine 846 consists of tools and configurations to perform simulations based on digital twins and on real data.

The OAM 860 comprises a Meta-specific slice Management Service (MnS) 862. The meta-specific MnS 862 may comprise a management function (MF) which handles the network/slice configuration and adaptation to address meta-SP requirements. Such service can be automated and dynamically interact with the meta aware network function 852. The meta-aware network function 852 may comprise a meta enabler 1052, 1152, or meta-control network function 1243 as described herein.

The meta aware network function 852 may be implemented byway of an application function (AF), a network function (NF), or an enabler server. This entity can be at the mobile core network 850 (option 2 illustrated in FIG. 8) or at the edge data network 840 (option 1 illustrated in FIG. 8). The meta aware network function 852 supports the discovery and requirements translation between the Meta Server 844 and the underlying network(s). The meta aware network function 852 can perform one or more of the following functions:
translate smart contracts to service requirements and network policies or management triggers; and
support QoS coordination.

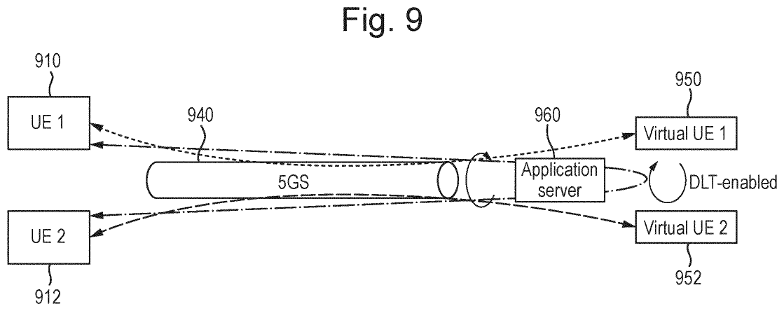

FIG. 9 illustrates possible sessions for a virtual experience service. FIG. 9 shows a first UE 910 and a second UE 912 communicating with an application server 960 over a 5G communication system (5GS) 940. A first multi-modal session carries traffic between the first UE 710 and a virtual first UE 950 via the application server 960. A second multi-modal session carries traffic between the first UE 912 and the virtual second UE 952 via the application server 960. A third multi-modal session carries traffic between the first UE 912 and the second UE 952 via the application server 960. The UEs 910, 912 may each comprise a remote unit 102, a user equipment apparatus 200, or a UE 710, 720, 810, 1010, 1020, 1110, 1120 as described herein.
1) the interaction between the UEs in the physical world and the virtual UEs at the metaverse (for providing sensor data/measurements and getting multimodal feedback) is provided by the first and second multi-modal sessions.
2) interaction between digital UEs (or avatar UE) interacting at the metaverse world. Such avatars can be located in the same or different servers or at the meta SP domain or at the end user digital wallet. Such interaction can be blockchain/DLT-enabled and may also be supported by the 5GS in certain implementations.
3) interaction between UE1 and UE2 via the network (which are in vicinity in metaverse but can be far away and served by different RATs/networks) is facilitated by the third multi-modal session. This may be for transactions between the UEs within the metaverse session. For example, a certain payment or a certain action of a user of the first UE 910 to be perceived to be a user of the second UE 912 in the physical world.
4) interaction of metaverse server with the UE1 and UE2 avatars to configure the interactions for the metaverse service and provide the digital environment as well as provide SP policies and optionally smart contracts for their interactions.

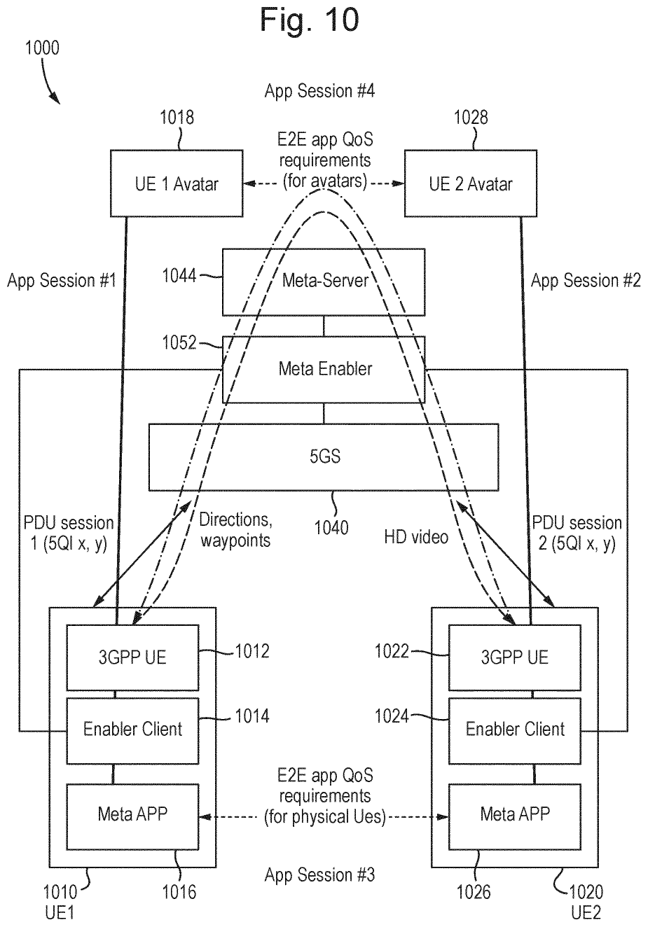

FIG. 10 illustrates a system 1000 having four different application sessions that can be present in a virtual experience service such as a mobile metaverse service. FIG. 10 illustrates a first UE 1010, a second UE 1020, a 5G system 1040, a meta-enabler 1052, a meta server 1044, a first virtual UE 1018 and a second virtual UE 1028. The first UE 1010 comprises a 3GPP modem 1012, an enabler client 1014 and a mobile metaverse application client 1016. The second UE 1020 comprises a 3GPP modem 1022, an enabler client 1024 and a mobile metaverse application client 1026. The 3GPP modems 1012, 1022 allow the UEs 1010, 1020 to communicate with the 5G system 1040. The first UE 1010 has a corresponding first virtual UE 1018, which may comprise an avatar. The second UE 1020 has a corresponding second virtual UE 1028, which also may comprise an avatar. The UEs 1010, 1020 may each comprise a remote unit 102, a user equipment apparatus 200, or a UE 710, 720, 810, 910, 912, 1110, 1120 as described herein. The meta enabler 1052 may comprise a meta-aware network function 852, a meta enabler 1152, or meta-control network function 1243 as described herein. The meta enabler 1052 may comprise an enablement service at an application layer which is tailored for virtual experience services delivered via a wireless communication network, such as the mobile meta verse.

Considering the QoS an PDU session aspects, four different Application Sessions #1, #2, #3 and #4 may be present in a mobile metaverse service. An end-to-end QoS requirement has different granularities and interpretations, and so the QoS requirements for the avatar-to-avatar interactions are different from the requirement for the physical UE to the avatar UE, and different from the physical UE to physical UE requirements. For example, Application session #3 is over a Uu or PC5 interface and may be used to exchange application context information and exchanging user data between the metaverse-compatible and metaverse-supported applications.

The arrangement of FIG. 10 may provide a mechanism for QoS coordination for mobile metaverse services as follows.

The meta enabler, which may be an application function, receives a metaverse service requirement with an SLA/multimodal and multi-session QoS requirement. The metaverse service requirement includes the UEs and PLMN to be involved as well as the ID/addresses for the digital copies/avatars (or the DN they reside).

The requirement to QoS requirements per application session and per network session are decoupled. The sessions include the 1) physical to digital UE session, 2) physical to physical UE session for UEs interacting in metaverse 3) digital to digital UE sessions (if mobile network is used for the communication).

The system further configures/identifies the QoS management capabilities to be supported for the service (alternative QoS, QoS prediction).

The system further determines the QoS profiles and app QoS attributes per multimodal session. For example, a new QoS profile to be provided and a new QoS attribute: such as relative distance between physical and digital UE.

The system further detects an expected or predicted change in one of the sessions (monitoring the QoS status/predictions from 5GC or Meta Server or UEs).

The system may be further arranged to perform simulations based on digital twins. Such simulations may be for identifying impact of each possible adjustment to the service or cell area or slice.

The system is further arranged to dynamically/pro-actively adjusting the QoS attributes per session (downgrade, upgrade) based on the simulations to ensure meeting received metaverse service requirement.

For the alternative QoS feature, the alternative QoS profile shall be decided based on the simulation outputs which can show the impact if each different combination of downgrade/upgrade is decided. Such impact may be per service or per cell area/network subnet or per slice.

The system is further arranged to send to the network or metaverse user/server the adjusted per session requirements.

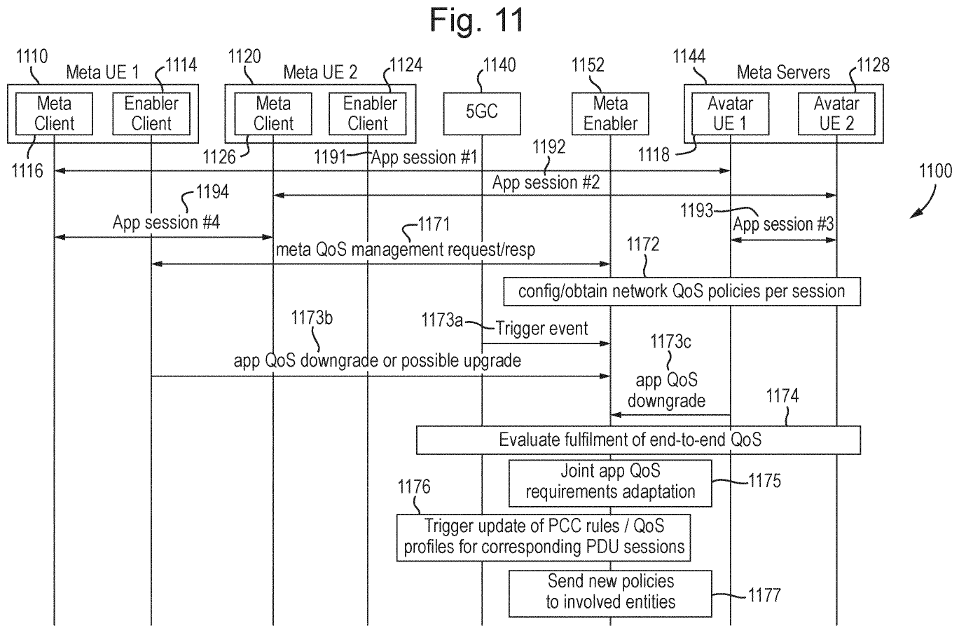

FIG. 11 shows the operation 1100 of an enablement server operating as a QoS coordination function. FIG. 11 shows a first meta UE 1110, a second meta UE 1120, a 5G core 1140, a meta enabler 1152, a first UE avatar 1118 and a second UE avatar 1128. The first meta UE 1110 comprises a 3GPP user equipment running a meta client 1116 and an enabler client 1114. The second meta UE 1120 comprises a 3GPP user equipment running a meta client 1126 and an enabler client 1124. Each meta UE 1110, 1120 may further comprise a 3GPP modem to facilitate communication with the 5G core 1140. The meta enabler 1152 may comprise an application function and may include a simulation engine. The first UE avatar 1118 and the second UE avatar 1128 may reside at a meta server 1144. The meta server 1144 may be located in a data network or an edge data network. The UEs 1110, 1120 may each comprise a remote unit 102, a user equipment apparatus 200, or a UE 710, 720, 810, 910, 912, 1010, 1020, as described herein. The meta enabler 1152 may comprise a meta-aware network function 852, a meta enabler 1052, or a meta-control network function 1243 as described herein.

Initially, all application sessions for Meta UEs have been established. The application sessions include UE1 and UE2 and avatar counterparts of UE1 and UE2. Four application sessions can be characterized as follows:
Application session 1, 1191: Meta client sends to Avatar UE 1 sensor data/measurements on the physical environment related to UE1. Avatar UE1 sends back haptic feedback to UE1 (for UE1 and/or UE2 and the environment)
Application session 2, 1192: Meta client sends to Avatar UE 2 sensor data/measurements on the physical environment related to UE2. Avatar UE1 sends back haptic feedback to UE2 (for UE1 and/or UE2 and the environment)
Application session 3, 1193: exchange of service/feedback data between avatars (such data will be translated and will be sent to respective partner UE)
Application session 4, 1194: sensor data/measurements/Meta SP policies are exchanged between Meta Ues (communication can be over sidelink or Uu)

The process 1100 begins at 1171, wherein the Meta service provider (SP) or a Meta user 1 (via enabler client 1114) sends a subscription/request message for a meta-specific QoS management. This is followed by a result as response or ACK. Such request message includes information elements as listed in table 2, below.

TABLE 2
meta QoS management request

| Information element | Status | Description |
|---|---|---|
| List of Ues | M | List of Ues for whom the meta-specifc QoS |
| | | management occurs |
| > UE/user ID | M | Identity of the VAL UE |
| > IP address | M | IP address of the UE |
| > Digital asset ID/info | M | The identity/info of the avatar corresponding to UE |
| Meta service ID | O | The service identity for whom the end-to-end QoS |
| | | management occurs. |
| End-to-end QoS requirements | O | The application QoS requirements/KPIs (latency, |
| | | error rate, . . . ) for the end-to-end mobile metaverse |
| | | service. |
| | | This may optionally include information which will |
| | | support the AF/enabler to identify the per session |
| | | QoS requirements (e.g. a flag indicating the use of |
| | | HD video for assisting the end-to-end session, a |
| | | video resolution/encoding required for the HD |
| | | video). |
| Service area | O | The area where the QoS management request |
| | | applies (in case of localized service). This can be |
| | | geographical area, or topological area. |
| Metaverse area info | O | The area at the metaverse world where the service |
| | | is expected to run (e.g. virtual land, virtual office) |
| Meta Environment metadata | O | The metadata for metaverse environment or a link |
| | | to download this data |
| Time validity | O | The time of validity of the requirement. |

At 1172, the meta enabler 1152 configures the application QoS parameters by decomposing the end-to-end QoS requirements (from UE 1 1110 to avatar UE1 1118 and/or avatar UE2 1128 and/or a Meta SP and back to UE1 1110 and/or UE2 1120) to application QoS parameters for each individual session (e.g. network session for UE 1, network session for UE 2, network session between avatars) which are part of the end-to-end application session. The meta enabler 1152 obtains or configures QoS policies per each session based on the decomposed QoS requirement.

At 1173a, the meta enabler 1152 receives a trigger event from the 5GC 1140 (for example, from the Session Management Function or Network Exposure Function of the 5G core 1140), denoting a QoS downgrade notification for the UE 1 session. The trigger event may comprise a QoS monitoring event (QNC) for one of the application sessions.

At 1173b, a QoS downgrade trigger event is sent from the Meta UE 1 1110 to the meta enabler 1152, the QoS downgrade trigger event denoting an application QoS degradation (experienced or expected) e.g. based on the experienced packet delay or packet loss for the Uu link (e.g. packet loss great than threshold value). The conditions for triggering the QoS downgrade indication from the meta UE1 1110 is based on the threshold that may be provided in advance by the Meta Enabler 1152 (at the end-to-end QoS management response by the Meta Enabler 1152). The QoS downgrade may alternatively be an upgrade. The QoS downgrade (or upgrade) may be for physical UE1 app sessions.

At 1173c, a QoS downgrade trigger event is sent from the avatar UE 1 1118 to the Meta Enabler 1152, denoting an application QoS degradation or upgrade (experienced or expected) e.g. based on the experienced packet delay or packet loss for the Uu link. For example, such a QoS downgrade trigger event may comprise a packet loss great than threshold value. The a QoS downgrade trigger event is for UE1 application sessions.

At 1174, the Meta Enabler 1152 evaluates the fulfilment/non-fulfilment of the end-to-end QoS based on the trigger event. Meta Enabler 1152 may retrieve additional information based on subscription to support its evaluation from the UEs or the avatar Ues/meta SP. This could be from the 5GC 1140 (NEF Monitoring Events as in 23.502, QoS sustainability analytics as in TS 23.288) or SEAL LMS (on demand location reporting for one or both UEs 1 and 2). The meta Enabler 1152 requests/receives supplement QoS status for sessions with dependencies from 5GC 1140 or Meta server 1144 or new simulations/samples from the Meta Sim Engine to identify impact if a certain adjustment is made.

The Meta Enabler 1152 may also trigger the initiation or retrieval (if simulations are running on the background) of simulations for different what-if hypotheses, and in particular to capture the possible output (performance/availability/failure rates) if different QoS related action is taken. For example, if QoS of app session #1 is upgraded as a compensation to session #2 downgrade, then QoS/resource management impact to other UEs of the same or different services need to be checked. The simulation runs all possible outcomes of a particular potential decision and does it for different combinations of decisions.

At 1175, the Meta Enabler 1152, based on the simulation outputs, determines an action, which is the QoS parameter adaptation of one or more of the links (QoS profile downgrade for the link receive QoS notification control, and QoS upgrade for the link which can be upgraded). The joint app QoS requirements adaptation may comprise either a joint QoS upgrade or a downgrade per session of meta service.

At 1176, the Meta Enabler 1152, acting as AF, sends to the 5GC 1140 (to SMF via NEF or to PCF via N5) a request for a change of the QoS profile mapped to the one or more network sessions (for UE 1 1110 and UE 2 1120 and their avatars) or the update of the PCC rules to apply the new traffic policy. The mechanism for such an update is specified in 3GPP TS 23.502 in clause 4.15.6.6a: AF session with required QoS update procedure. The update of the PCC rules may include a PDU set marking change.

At 1177, the Meta Enabler 1152 sends the new application or network QoS policies/parameters to the involved entities (physical and metaverse UEs and meta SP).

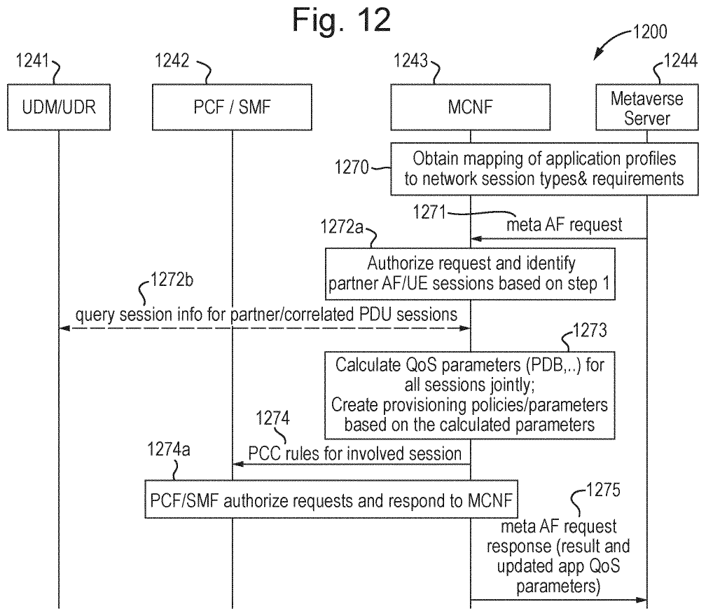

FIG. 12 illustrates a method 1200 for the coordination of PDU sessions at a meta-control NF (MCNF) 1243. FIG. 12 shows a Unified Data Management (UDM)/User Data Repository (UDR) 1241, a Policy Control Function (PCF)/Session Management Function (SMF) 1242, the meta-control NF (MCNF) 1243, and a metaverse server 1244. The meta-control network function 1243 may comprise a meta-aware network function 852, or a meta enabler 1052, 1152 as described herein. In the context of MCNF 1243, “meta-control” refers to a control function at the core network which is configured (e.g. by OAM) to provide control plane service(s) which are tailored to support a virtual experience service. The virtual experience service may comprise mobile metaverse sessions.

The method 1200 begins at 1270, wherein the Meta Control NF (MCNF) 1243 obtains the mapping of application to network session types (multimodal) and traffic requirements for a metaverse service (such info can be provided by OAM or by the meta SP).

At 1271, the MCNF 1243 receives the AF request from meta-SP/meta UE's AF for setting up or update a session with certain QoS.

At 1272, the MCNF 1243 correlates the request with the partner sessions (UE IDs and AF-Service-IDs) within the metaverse service. Such correlation can be based on the mapping at step 1270 or by requesting the mapping information from UDM/UDR 1241.

At 1273, the MCNF 1243 calculates the QoS parameters (e.g. PDB) for the session and all partner sessions that need to change. Such calculation can be based on simulating all possible hypotheses in Meta Sim Engine or Meta Server 1244 (using digital objects as twins for deriving data). MCNF 1243 derives Alternative Service requirements for one or more of the involved sessions based on the use of digital-twin based simulations.

At 1274, the MCNF 1243 provides the updated parameters for each session to the PCF/SMF 1242 to trigger the PCC rules update. The PCC rules update may comprise a change of QoS profile or parameters in coordinated manner. Such parameters may be updated by the meta service provisioning policies/parameters (at MCNF 1243 or at PCF/SMF 1242 including such new meta control function). The updated parameters for each session may be sent to one or more PCF/SMFs involved in the sessions.

At 1274a, the PCF/SMF 1242 authorizes the request and respond to the MCNF 1243.

At 1275, after authorization from PCF/SMF 1242, the MCNF 1243 exposes the updated QoS expected/predicted parameters to the AF or meta-UE (via AF).

There is disclosed herein a mechanism to configure and coordinate the QoS for a plurality of sessions in a virtual experience service to ensure meeting end to end QoS/QoE requirements. Some of these sessions may be multimodal. The virtual experience service may be a mobile meta service.
There is described a mechanism for QoS coordination for multiuser and multimodal mobile meta services. This is performed by way of introduction of an entity which can be at the 5GC or at the edge/cloud SP domain and supports the requirements of translation between the Meta Server and the underlying network(s) and optimizes performance by compensating for possible QoS changes for one or more sessions.

Current QoS coordination and compensation mechanisms consider only dependent sessions in the physical space. Also, for XR the QoS coordination is for multimodal services, but not touching the idiomorphs of the meta services. Such idiomorphs may comprise multi-session, multimodal including different communication endpoints.

There is provided a mechanism for the application of QoS coordination at AF/enablement server. There is also provided a mechanism for the PDU session QoS coordination at MCNF.

Accordingly, there is provided a method for configuring a plurality of QoS parameters for a mobile metaverse service, the method comprising: obtaining an application service requirement corresponding to a plurality of devices in both physical and virtual space, wherein the plurality of devices are within the mobile metaverse service; decomposing the requirement to a plurality of session requirements, wherein the sessions comprise communication session between physical devices, digital devices, network entities, application entities or a combination thereof; configuring a set of joint QoS parameters for the plurality of sessions based on the per session requirements; sending the configured joint QoS parameters to one or more network or application entities.

The obtained application service requirement may comprise a set of performance requirements for the metaverse service, subscriptions of the involved devices, identities and addresses of the involved network elements, a request for coordinating the QoS for the mobile metaverse service, a metaverse application service profile, a service area for which the requirement applies, or a combination thereof.

The obtained application service requirement may be received from a meta service provider and/or a network management system.

The per session requirements may be either network session requirement or application session requirements, and may comprise QoS and/or QoE targets.

The configuring of a set of joint QoS parameters may be based on running simulations at the virtual space based on digital twins of the physical devices under hypothetical QoS parameterization for one or more sessions.

The simulation running may further comprise: requesting simulations from a simulation engine based on digital twins for a set of hypothetical parameters; receiving simulation outputs based on the request; processing the simulation outputs to determine each QoS parameters per session. The QoS parameters may be determined per session to optimize the metaverse service performance.

The configured joint QoS parameters may determine service provisioning policies for the mobile metaverse service to be applied by the corresponding network function.

The method may further comprise: receiving an event related to a QoS change for one or more sessions, wherein the event is received by a device or a network element; adapting the configuration of the set of joint QoS parameters for the plurality of sessions based on the received event; and sending the adapted joint QoS parameters to one or more network or application entities.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
receive an application service requirement corresponding to a plurality of devices, the plurality of devices operating in physical space, or in a virtual space of a virtual experience service, or both;
decompose the application service requirement to a plurality of session requirements, wherein the plurality of session requirements apply to a plurality of communication sessions, and the plurality of communication sessions are provided between devices in both the physical space and the virtual space;
derive a set of joint quality of service parameters for the plurality of sessions based at least in part on the plurality of session requirements; and
send the set of joint quality of service parameters to one or more network entities in a wireless communication network.

2. The apparatus of claim 1, wherein the plurality of devices operating in the physical space or the virtual space, or both, comprise: physical devices, digital devices, network entities, application entities or a combination thereof.

3. The apparatus of claim 1, wherein the application service requirement comprises at least one of:
a set of performance requirements for the virtual experience service;
subscriptions associated with the plurality of devices;
identities and addresses of the plurality of devices;
a request for coordinating the quality of service for the virtual experience service;
a virtual experience application service profile; and
a service area for which the application service requirement applies, or a combination thereof.

4. The apparatus of claim 1, wherein the application service requirement is received from a virtual experience service provider and/or a network management system.

5. The apparatus of claim 1, wherein the plurality of session requirements are network session requirements or application session requirements and comprise quality of service and/or quality of experience targets.

6. The apparatus of claim 1, wherein the at least one processor is configured to cause the apparatus to derive the set of joint quality of service parameters based on running at least one simulation at the virtual space, the simulation using digital twins of the plurality of devices.

7. The apparatus of claim 6, wherein to run the at least one simulation, the at least one processor is configured to cause the apparatus to:
request simulations from a simulation engine based on digital twins for a set of hypothetical parameters;
receive simulation outputs based on the requested simulations; and
process the simulation outputs to determine quality of service parameters per session.

8. The apparatus of claim 1, wherein the joint quality of service parameters determine service provisioning policies for the virtual space to be applied by at least one respective network function.

9. The apparatus of claim 1, wherein the at least one processor is configured to cause the apparatus to:
receive an event related to a quality of service change for one or more sessions of the plurality of sessions;
adapt the set of joint quality of service parameters for the plurality of sessions based on the event; and
send the adapted set of joint quality of service parameters for the plurality of sessions to one or more network entities or application entities.

10. The apparatus of claim 9, wherein the event related to a quality of service change is received from one of the plurality of devices operating in the physical or the virtual space, or from a network element in the wireless communication network.

11. A method performed by an apparatus, the method comprising:
receiving an application service requirement corresponding to a plurality of devices, the plurality of devices operating in physical space, or in a virtual space of a virtual experience service, or both;
decomposing the application service requirement to a plurality of session requirements, wherein the plurality of session requirements apply to a plurality of communication sessions, and the plurality of communication sessions are provided between devices in both the physical space and the virtual space;
deriving a set of joint quality of service parameters for the plurality of sessions based at least in part on the plurality of session requirements; and
sending the set of joint quality of service parameters to one or more network entities in a wireless communication network.

12. (canceled)

13. (canceled)

14. The method of claim 11, wherein the application service requirement is received from a virtual experience service provider and/or a network management system.

15. The method of claim 11, wherein the plurality of session requirements are network session requirements or application session requirements and comprise quality of service and/or quality of experience targets.

16. (canceled)

17. (canceled)

18. The method of claim 11, wherein the derived joint quality of service parameters determine service provisioning policies for the virtual space to be applied by at least one respective network function.

19. The method of claim 11, further comprising:
receiving an event related to a quality of service change for one or more sessions of the plurality of sessions;
adapting the set of joint quality of service parameters for the plurality of sessions based on the event; and
sending the adapted set of joint quality of service parameters for the plurality of sessions to one or more network entities or application entities.

20. (canceled)

21. An processor for wireless communication, comprising:
at least one controller coupled with at least one memory and configured to cause the processor to:
receive an application service requirement corresponding to a plurality of devices, the plurality of devices operating in physical space, or in a virtual space of a virtual experience service, or both;
decompose the application service requirement to a plurality of session requirements, wherein the plurality of session requirements apply to a plurality of communication sessions, and the plurality of communication sessions are provided between devices in both the physical space and the virtual space;
derive a set of joint quality of service parameters for the plurality of sessions based at least in part on the plurality of session requirements; and
send the set of joint quality of service parameters to one or more network entities in a wireless communication network.

22. The processor of claim 21, wherein the plurality of devices operating in the physical space or the virtual space, or both, comprise: physical devices, digital devices, network entities, application entities or a combination thereof.

23. The processor of claim 21, wherein the application service requirement comprises at least one of:
a set of performance requirements for the virtual experience service;
subscriptions associated with the plurality of devices;
identities and addresses of the plurality of devices;
a request for coordinating the quality of service for the virtual experience service;
a virtual experience application service profile; and
a service area for which the application service requirement applies, or a combination thereof.

24. The processor of claim 21, wherein the at least one controller is configured to cause the processor to derive the set of joint quality of service parameters based on running at least one simulation at the virtual space, the simulation using digital twins of the plurality of devices.

25. The processor of claim 24, wherein to run the at least one simulation, the at least one controller is configured to cause the processor to:
request simulations from a simulation engine based on digital twins for a set of hypothetical parameters;
receive simulation outputs based on the requested simulations; and
process the simulation outputs to determine quality of service parameters per session.
